(19) United States
(12) Patent Application Publication
(10) Pub. No.: US 2019/0210388 A1
(43) Pub. Date: Jul. 11, 2019

(54) APPARATUS FOR REGISTERED FOIL STAMPING AND A PROCESS THEREFOR

(71) Applicant: Ashok CHATURVEDI, NEW DELHI, DELHI (IN)

(72) Inventor: Ashok CHATURVEDI, NEW DELHI, DELHI (IN)

(21) Appl. No.: 16/336,208

(22) PCT Filed: Sep. 25, 2017
(86) PCT No.: PCT/IN2017/050424

§ 371 Date: Mar. 25, 2019

(30) Foreign Application Priority Data
Sep. 26, 2016 (IN) 201611032811

(51) Int. Cl. B41K 1/26; B41F 16/00

(52) U.S. Cl. CPC B41K 1/26; B41P 2219/23; B41P 2219/21; B41F 16/006

(57) ABSTRACT

This invention relates to an apparatus and a process for transferring images, barcodes, optical patterns, latent images, Fresnel lenses, holograms, sterling lenses etc from a stamping foil (116) at desired locations on to a substrate (110) such as paper, polymeric film, flexible laminates, woven or non-woven substrate and combination of these in roll to roll form and more particularly to an apparatus and a process for registered transfer of images, barcodes, optical patterns, latent images, Fresnel lenses, holograms, sterling lenses etc from a stamping foil (116) to a substrate (110) in accurate registered relation. The use of high resolution and high speed sensors (135, 160, 162, 164, 166, 168) provides continuous precise data to the regulating device which results in the continuous correction in the corresponding position of stamping punch/es (137) and stamping foil (116) to match the locations on substrate (110). This provides accurate registered transfer of prints, latent images or Fresnel lenses on the substrate (110) with efficient utilization of stamping foil (116).

### FIELD OF THE INVENTION

This invention relates to an apparatus and a process for transferring images, barcodes, optical patterns, latent images, Fresnel lenses, holograms, sterling lenses etc. from a stamping foil with registration accuracy to a substrate such as paper, polymer, flexible laminates, woven or non-woven and combination of these in roll to roll form and more particularly to an apparatus and process for registered transfer of images, barcodes, optical patterns, latent images, Fresnel lenses, holograms, sterling lenses etc. from a stamping foil to a substrate in accurate registered relation.

### BACKGROUND

In today's competitive consumer market, decorative packaging has become very important and is used as a marketing tool to attract the attention of potential shoppers. It is known in the art to create or transfer artistic text, latent images, holograms, prints or Fresnel lenses on a particular area of a film or laminate. Such Fresnel lens films are known to be used for packaging to make them more attractive.

Further, it is desired and well known in the art to configure such artistic text, latent images, holograms, prints or Fresnel lenses by lamination with the film having artistic text, latent images, holograms, prints or Fresnel lens to another substrate such as another polymeric film, or fibrous substrates such as paper, or paper board, synthetic fibrous substrates, etc.

While incorporating artistic text, latent images, holograms, prints or Fresnel lenses over substrates using hot or cold stamping process known in the art, over a specific area significant portion of stamping foil is wasted and also the stamping does not transfer the lenses/images exactly over the desired location on the substrate consistently and need to be corrected every time. This leads to reduction in production speed and not a high quality product as desired.

A process for transferring a foil print from a foil on to a substrate and an apparatus for carrying out that process are known from DE 32 10 551 C2. That process and the apparatus are suitable for virtually endlessly impressing a substrate in the form of a flexible web of material, with a print, in the direction of forward feed movement of the substrate. The substrate may be for example a magnetic strip on a ticket or a decorative endless strip which covers a corresponding print portion, that is to say a ticket or the like, in the direction of transportation movement of the substrate from one edge of the corresponding desired location as far as the oppositely disposed edge thereof.

### SUMMARY OF THE INVENTION

According to the present invention images, barcodes, optical patterns, latent images, Fresnel lenses, holograms, sterling lenses etc. are provided by means of a stamping foil on a substrate, in registered relationship at desired location. More specifically, it is possible to provide an accurately defined and exact association of the foil images, barcodes, optical patterns, latent images, Fresnel lenses, holograms, sterling lenses etc. to the desired portions of the substrate to be stamped in roll form. The rotary angular position of the stamping punch segments of stamping roller, and a predetermined identification of desired location of the substrate and stamping foil can be synchronized to each other by means of a regulating device. Multiple high speed and high resolution optical sensors are positioned to sense the position of substrate, stamping foil, stamping punch and stamped substrate or foil, which provide input to a regulating device. The identification on the substrate or each desired location of the substrate may involve suitable print marks which are detected by optical sensors and position data from these sensors is continuously fed to the regulating device to generate controlling instructions to various drives.

According to an embodiment of the invention, the substrate for stamping is fed from an unwind roll of the substrate through a feed roller. An adjusting roller is provided on the rewind side of stamping station, which acts in tandem with feed roller to keep the speed and tension of the substrate constant.

According to the invention a supply device may be used with the apparatus to provide a continuous length of substrate. A device for applying a patch of primer or an adhesive on the substrate in registered relationship or all over may also be provided to enhance bonding strength.

According to further embodiment, the stamping foils are fed from an unwind roll of the stamping foil through a feed roller. An adjusting roller is provided on the rewind side of stamping station, which act in tandem with feed roller to keep the tension of the foil constant and to adjust the foil with respect to pitch of stamping punch and substrate for accurate stamping position on the substrate.

Print marks on the foil or the prints thereon are sensed and determined by optical sensors and adapted by the regulating device. The drive of the feed roller and adjusting roller is controlled by servo motors under instructions from regulating device, which continuously rotate the rollers clockwise or anti clockwise to adjust the stamping foil according to position of flexible substrate so that the stamping foil falls exactly over the desired location on the substrate, where the stamping is required.

The stamping roller provided at stamping station is driven by a servo motor connected to regulating device. An optical sensor is provided to sense the position of stamping punch on the stamping roller. The position data of the stamping punch is sent to regulating device, which in turn controls rotation of the servo motor to adjust the stamping roller to register it with respective positions of substrate. A pressure roller is also provided against the stamping roller to provide necessary pressing of foil over substrate for stamping.

In addition to these optical sensors described above, another optical sensor is provided to monitor the used stamping foil. The positional data of the stamped portion of the foil is detected and the data is sent to the regulating device to fine-tune the position of the stamping foil. The positional data is detected by the sensor and sent to regulating device, which in turn control the feed rollers and adjusting rollers to correct the position of the stamping foil with respect to substrate.

Another sensor i.e. high resolution, high speed inspection camera is provided to detect the variation in the stamped substrate. The camera ensures that the stamping on the substrate is done on the accurate location where it is required. In case any variation in stamping is detected from the desired stamping location, then variation data is sent to regulating device for further correction in the position of different components viz. stamping foil and stamping roller.

According to present invention, a digital regulating device is provided for control and operation of various components of the system, as described above. The regulating device is connected on its input side to different optical sensors and on its output side to different control drives for feed rollers, adjusting rollers and the stamping roller. The data related to diameter of rollers and pitch etc. are pre-determined and fed by user into the regulating device. There is at least one optical sensor associated with each of substrate, stamping foil and stamping roller, on unwind side of stamping station and at least one optical sensor associated with stamped substrate and used stamping foil on rewind side of stamping station are provided, which are connected to said regulating device. The sensor associated with the flexible substrate on unwind side, sends input to regulating device about the pitch and corresponding position of the substrate which is going to be stamped. Based on the positional data sent by the optical sensor associated with substrate, position of the stamping punch is adjusted. Similarly, the markings on the stamping foil are detected by means of the optical sensor for stamping foil on the unwind side and the data corresponding to the detected markings are fed to the regulating device. The position data of the stamping punch is sensed by optical sensor associated with stamping roller and sent to regulating device. Based on input from optical sensors associated with substrate and stamping foil on unwind side of stamping station, the regulating device calculates, compares and controls the rotation of the stamping roller drive which adjusts the position of stamping punch by clock-wise/anti clock-wise rotation of stamping roller to ensure that the stamping is done exactly at required position on the substrate when it comes under stamping roller.

The regulating device may be a PLC (programmable logic controller) or a computer based system capable of receiving multiple inputs from sensors, calculating, comparing & providing outputs for corresponding controlling devices such as servo motors etc. according to the algorithms programmed by user.

According to further embodiment, as discussed above at least an optical sensor is provided on the rewind side of the stamping station to sense the corresponding position of used stamping foil after stamping and before rewind and in case there is any deviation, then the deviation data is sent to regulating device for additional corrective measures i.e. by clockwise/anticlockwise rotation of stamping foil feed roller and adjusting roller servo drives. This happens continuously in close loop in addition to the initial adjustment for synchronisation of substrate, stamping foil and stamping roller to achieve even better positional accuracy of stamping.

In addition to above, at least a high resolution, high speed inspection camera is provided on the rewind side of the stamping station to sense the corresponding position of stamped substrate after stamping before rewind.

In case there is any deviation, then the deviation data is sent to regulating device for additional corrective measures i.e. to fine tune the position of stamping punch and stamping foil. According to another embodiment of invention a process for transferring prints, latent images, Fresnel lenses etc. from a stamping foil to a substrate is described. The process for transferring images, barcodes, optical patterns, latent images, Fresnel lenses, holograms, sterling lenses etc. from a stamping foil with accurate registration on a flexible substrate in roll to roll form, the process comprising the steps of:

providing a flexible substrate (110) from a substrate unwind roll (140), the substrate (110) pulled by at least a pair of feed rollers (132A) and adjusting rollers (132B) working in tandem;

reading the positional data of the registration mark (111) on the substrate (110) by the sensor (160) and sending the positional data to regulating device (158);

adjusting the stamping punch (137) on the stamping roller (136) according to positional data of the registration mark (111) on the substrate (110);

providing a stamping foil (116) from an unwind roll (142), the stamping foil drawn off by at least a pair of feed rollers (144A) and adjusting rollers (144B) working in tandem;

adjusting the corresponding positions of the stamping foil (116) with respect to corresponding position of the substrate (110) and the stamping punch (136);

transferring images, barcodes, optical patterns, latent images, Fresnel lenses, holograms, sterling lenses from stamping foil (116) to the substrate (110) at the stamping station (134) by stamping; and collecting the substrate on a rewind roll (154) and used stamping foil (116) on rewind roll (156).

According to method the substrate is fed from an unwind by a pair of feed rollers, which act in tandem with another pair of rollers i.e. adjusting rollers, which help in keeping the line speed and tension of the substrate constant. Input data for repeat pitches, eyermarks/print marks on the substrate is fed to the regulating device by the user manually or automatically sensed with optical sensor associated with substrate and fed to regulating device. The input from sensor is fed to the regulating device, which in turn adjusts the position of stamping punch on the stamping roller with respect to position on substrate by clock-wise/anti clock-wise rotation of stamping roller to ensure that the stamping is done exactly at same required position on the substrate at the corresponding sensed pitch.

Position of stamping foil is also corrected with respect to corresponding position of substrate and stamping punch. Eye mark on stamping foil is sensed over the foil feed roller by a high speed and high definition optical sensor. The drive to the feed roller is controlled by regulating device as described above. The drive to the feed roller and adjusting roller is driven by a servo motors which continuously rotates the rollers clockwise or anti clockwise ensuring that the punching position on stamping foil matches with corrected position of the stamping punch so that the stamping foil falls exactly over the location on the substrate where the stamping is required which also coincides with the stamping punch pressure.

The stamping foil is supplied from an unwind roll, and passes through feed rollers and adjusting roller working in tandem to pull the foil back and forth to correct the position of stamping foil with respect to eye-mark on substrate and stamping punch position. The stamping foil coming out of the feed roller passes over the substrate web under stamping roller. Both feed and adjusting rollers work in tandem such that the tension of stamping foil between these units, passing between the substrate and the stamping roller remain constant irrespective of the continuous correction in stamping foil position taking place to match the location on substrate, stamping punch and the stamping foil.

Used stamping foil after the stamping is continuously monitored by sensor provide on rewind side which detects the pitch and/or centre of the stamped out part with respect to corresponding eye mark on the foil, which according to an embodiment of invention is fixed and if there is any deviation that deviation data is sent to regulating device and based on this deviation data the position of the stamping foil is further continuously corrected to provide accurate stamping.

Stamped substrate is also sensed by a high resolution camera provided on rewind side of stamping station, which checks that the stamping is performed at desired location, and data related to that sensing is sent to regulating device. In case of any deviation, correction measures i.e. adjusting the position of stamping foil and stamping punch are performed to ensure that the stamping is done on accurate location.

According to invention the different sensing devices provided on unwind side and on rewind side of the stamping station form a close loop correction mechanism to ensure stamping at accurate location.

### BRIEF DESCRIPTION OF THE DRAWINGS

Further details, features and advantages are apparent from the following description of embodiments of the apparatus according to the invention for carrying out the process according to the invention, which are illustrated in the drawing in which:

FIG. 1 is a view of a portion of a substrate to be provided with prints, latent images or Fresnel lenses in an accurate register relationship, and

FIG. 2(a) shows a substrate according to an embodiment of present invention and FIG. 2(b) stamping foil having stamping foil transfer areas with prints, latent images or Fresnel lenses having efficient utilization of foil;

FIG. 3 shows a block diagram of the apparatus for applying prints, latent images or Fresnel lenses to a flexible substrate in roll form; and

FIG. 4 is showing a section of stamping roller with stamping punches as is used in the apparatus shown in FIG. 3.

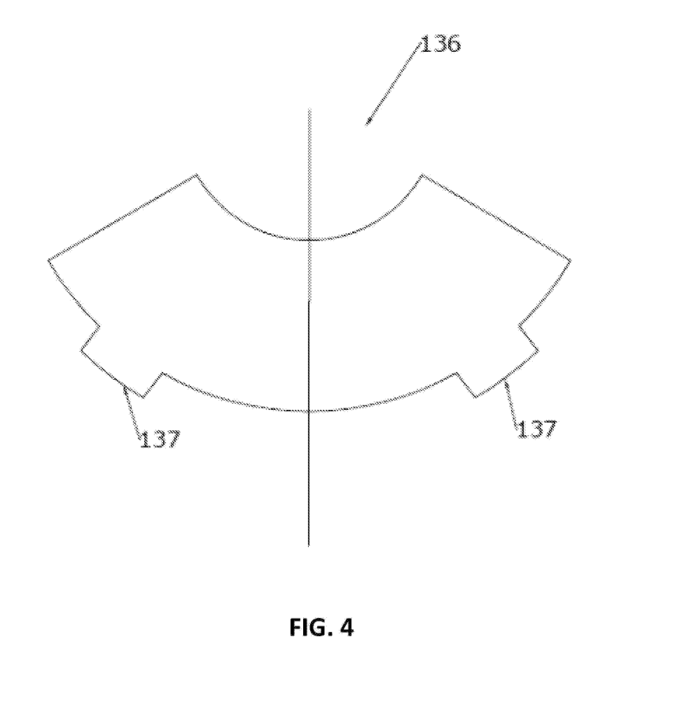

### DESCRIPTION OF THE PRESENT INVENTION

For a thorough understanding of the present invention, reference is made to the following detailed description in connection with the above-mentioned drawings. Although the present invention is described with reference to exemplary embodiments, the present invention is not intended to be limited to the specific forms set forth herein. It is understood that various omissions and substitutions of equivalents are contemplated as circumstances may suggest or render expedient, but these are intended to cover the application or implementation without departing from the spirit or scope of the present invention. Further, it will nevertheless be understood that no limitation in the scope of the invention is thereby intended, such alterations and further modifications in the figures and such further applications of the principles of the invention as illustrated herein being contemplated as would normally occur to one skilled in the art to which the invention relates. Also, it is to be understood that the phraseology and terminology used herein is for the purpose of description and should not be regarded as limiting. Further, reference herein to “one embodiment” or “an embodiment” means that a particular feature, characteristic, or function described in connection with the embodiment is included in at least one embodiment of the invention. Furthermore, the appearances of such phrase at various places herein are not necessarily all referring to the same embodiment. The terms “a” and “an” herein do not denote a limitation of quantity, but rather denote the presence of at least one of the referenced item.

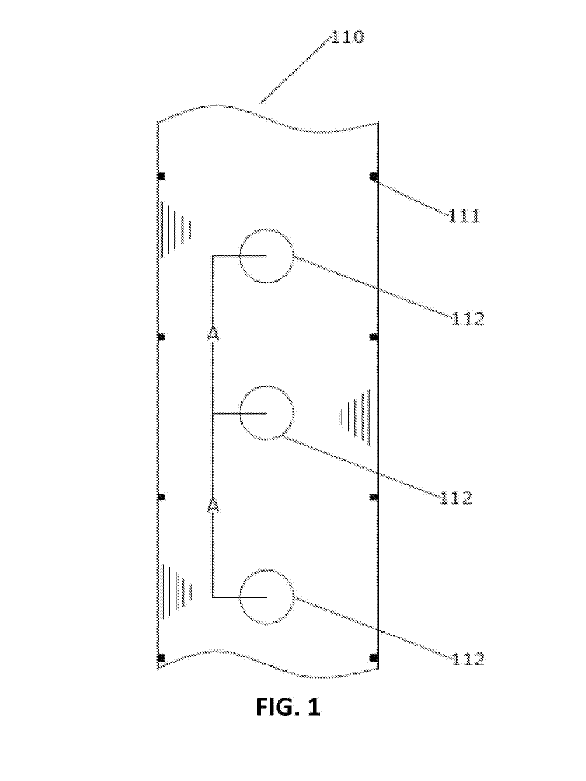

FIG. 1 shows a portion of a flexible substrate (110) which has selective desired locations (112) for stamping. Each desired location (112) is registered with respect to an eye mark (111) and at a spacing A or pitch. The prints, latent images or Fresnel lenses are to be provided in accurately registered relationship with eye mark over the desired location (112). The eye mark may be a pre-printed text, image or any other reference mark available on the substrate. The line speed of substrate (110) from unwind is kept constant and the eye-mark (111) is detected by an optical sensor (160) and the eye-mark sensing information is sent to a regulating device (158). The optical sensor is a high resolution and high speed sensor capable of capturing and transmitting information at high line speeds of the substrate (110).

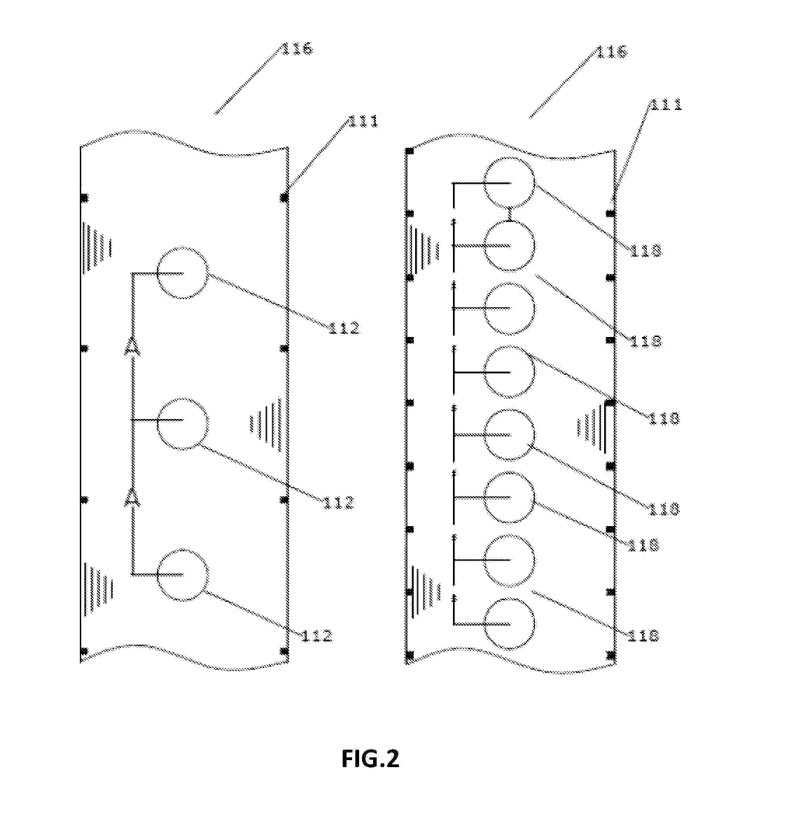

FIG. 2a shows a portion of the web substrate (110) with pitches A of the desired locations, where stamping of images, barcodes, optical patterns, latent images, Fresnel lenses, holograms, sterling lenses etc are required. Data related to eye mark pitches on the substrate is initially fed to the regulating device (158) by user and once the stamping process starts it is automatically sensed by optical sensor and fed to the regulating device for necessary corrections.

FIG. 2(b) shows a stamping foil (116) with transfer areas (118) having prints, latent images or Fresnel lenses which are required to be transferred over desired locations (112) on the flexible substrate (110) in registered relationship. The pitch (S) of transfer area (118) on stamping foil (118) may be equal or less than the pitch (A) of the desired locations (112) on the substrate (110) i.e. pitch A is significantly lesser than the pitch S of transfer areas (118) leaving gaps between two consecutive transfer areas (118) too large and the stamping foil (116) length is wasted. To avoid wastage and to efficiently use the stamping foil (116) the pitch(S) on the stamping foil (116) is reduced to leave minimum required gap between the two consecutive transfer areas (118).

In case of specific transfer areas (118), which in the direction of transportation movement of the stamping foil (116) are at a spacing ‘S’ from each other, the spacing ‘S’ or pitch corresponds to the stamping punch (137) and to the spacing ‘A’ of surface portions (114) of adjacent print portions (112) on the substrate (110) thereof. If the flexible substrate (110) has more than one rows of printed portions (112), the stamping foil (116) also required to be configured with corresponding transfer areas (118). During the process of stamping, the forward speed of the stamping foil (116) is either kept slower than that of substrate (110) or stamping foil (116) is pulled back and forth to adjust transfer area (118) such that the transfer area (118) of the stamping foil (116) exactly overlaps the desired location (112) on the substrate.

In an exemplary embodiment, the substrate (110) and stamping foil (116) start moving at same speed but since the stamping foil (116) needs to travel less distance than the substrate (110) due to smaller pitch ‘S’ on the stamping foil (116) than the pitch ‘A’ on the substrate (110), the stamping foil (116) is pulled back while substrate (110) is still moving forward. The stamping foil (116) is again made to move forward in tandem with the substrate (110) at the same speed to finally stop at precise registration with the substrate (110), when the substrate stops after covering pitch ‘A’. This is done to avoid effect of inertia causing over run.

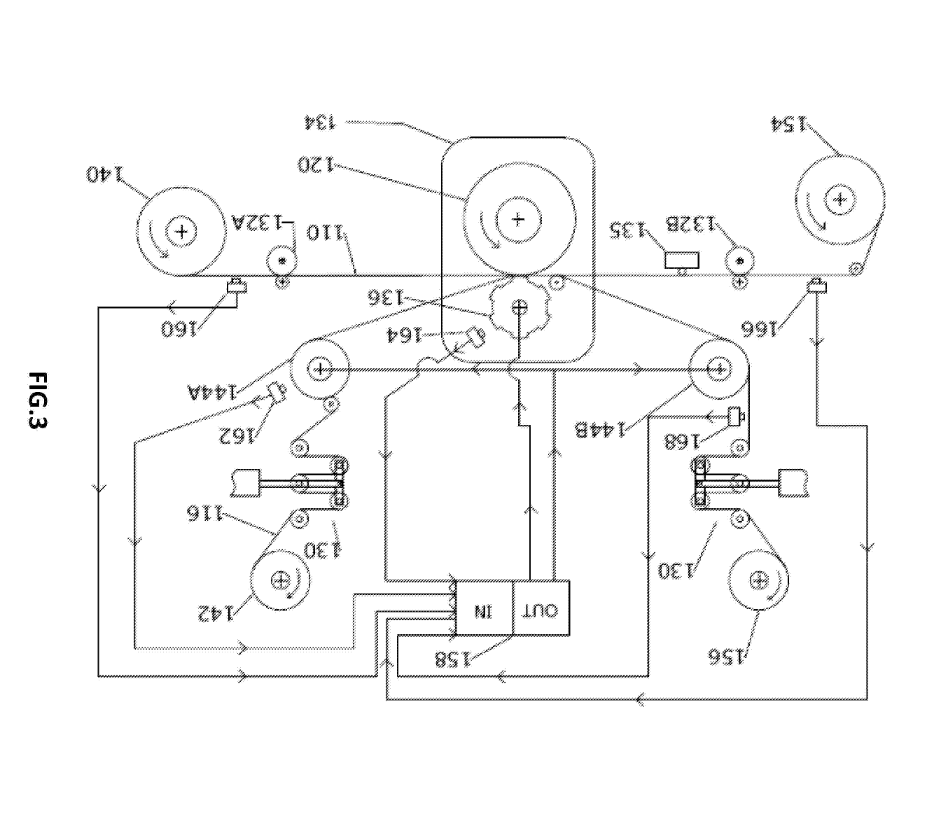

FIG. 3 shows an apparatus (128) for applying prints, latent images or Fresnel lenses (see FIG. 2) from a stamping foil (116) to a flexible substrate (110) in roll form. The flexible substrate (110) is provided from an unwind roll (140) and pulled off the unwind roll (140) by at least a pair of feed rollers (132A) and adjusting rollers (132B) provided on unwind and rewind side of the stamping station (134) respectively and fed to a stamping station (134). Stamping station comprises of a stamping roller (136) and a pressure roller (120) provided under stamping roller (136).

The line speed of substrate (110) is kept constant and eye-mark (111) or any other registration marks situated on substrate are detected by an optical sensor (160). The sensor (160) is a high speed and high resolution optical sensor such as a high resolution camera or photovoltaic cell etc. The line speed data of the substrate is fed to the regulating device from feed roller drive as R.P.M and diameter of the driven feed roller is already fed in the regulating device. This speed data is used to adjust the speed of the stamping foil (116). The input from optical sensor (160) regarding position of eye mark on the substrate (110) is fed to a regulating device (158).

The adjusting rollers (132B) are provided on rewind side of the stamping station, act in tandem with feed rollers (132A) to keep the tension of the substrate uniform throughout the stamping process. A device tension sensor (135) for measurement of tension may be provided between the feed rollers (132A) and adjustment rollers (132B), which measures tension in the substrate and sends signals to regulating device. If at any instance tension of the substrate measured by the device (135) is below a present value, the regulating device sends signals to drive of adjusting rollers and speed of adjusting rollers (132B) increased subsequently to increase the tension in the substrate. On the other hand if tension of the substrate increases at any instance the regulating device sends signal again to the drive of adjusting roller and speed of the adjusting rollers (132B) is decreased. This happens continuously in close loop to maintain the tension in the substrate web (110).

The stamping foil (116) is provided from an unwind roll (142). The stamping foil (116) is drawn off the unwind roll (142) by the feed rollers (144A) and fed to a stamping station (134). Another set of rollers i.e. adjusting rollers (144B) are provided on rewind side of the stamping station, which act in tandem with feed rollers (144A) to pull the stamping foil (116) forward or backward to adjust the stamping foil (116) according to the corresponding pitch on the substrate (110). As the feed rollers (144A) and adjusting rollers (144B) rotate continuously in clockwise and anti-clockwise direction to adjust the stamping foil (116), an accumulator (130) or similar arrangement may be provided to accommodate movement of stamping foil (116) and maintain tension in the stamping foil (116). In an exemplary embodiment of an accumulator driven by pneumatic actuator is provided for the purpose.

According to present invention, the eye-mark (111) or any other registration marks situated on the stamping foil (116) are detected by another sensor (162) associated with the stamping foil. The sensor (162) is a high speed and high resolution optical sensor such as a high resolution camera, photovoltaic cell etc. The input from the sensor (162) regarding position of eye mark on the stamping foil (116) is fed to the regulating device (158), which in turn controls the feed rollers (144A) and the adjusting rollers (144B) and adjusts the position of the stamping foil (116) by clock-wise/anti clock-wise rotation of feed rollers (144A) and adjusting rollers (144B) in tandem to ensure that prints, latent images or Fresnel lenses come exactly over the desired location (112) on the substrate (110) at the corresponding sensed pitch.

A stamping roller (136) with stamping punches (137) is configured in such a way that the stamping foil (116) & the substrate (110) web pass under the roller. The substrate (110) is pressed by a pressing roller (120). The stamping roller (136) is driven by a servo motor & may also be fitted with rotary encoder. The diameter and angular pitch of the stamping punches (137) are fed into the regulating device (158). At least an optical sensor (164) senses the edge of the stamping punch (137) and sends data to the regulating device (158). The regulating device (158) compares and calculates the rotary corrections required in the stamping roller (136) to register the stamping punch (137) with the corresponding desired location (112) and transfer areas (118) on the substrate (110) and stamping foil (118), respectively. The backup pressure for stamping is provided by up movement of the pressure roller (120). The stamping punches (137) are heated to the desired temperature required for transfer from the stamping foil (116), by electric heaters, hot oil circulation or any other suitable means which are known in the art.

According to invention at least one sensor (168) associated with used stamping foil on rewind side, is provided after stamping station to sense the eye mark or registration mark and transferred impression/portion on used stamping foil (116). The sensor (168) is a high speed and high resolution optical sensor that detects the transferred portion (118) location/pitch with respect to the eye-mark (111) location/pitch on the used stamping foil (116). The sensor (168) uses a reference on the transferred portion such as centre or periphery of the transferred portion and analyses it with respect to eye-mark on the foil. If there is any deviation from the expected relation with respect to eye-mark it sends the information to regulating device for necessary correction by adjusting feed roller (144A) and adjusting roller (144B). The correction is to further improve the accuracy of the stamping locations on the substrate (110). Another sensor (166) associated with stamped substrate is also provided to check the accuracy of stamping on the substrate. In case, there is any deviation from the desired stamping location, the deviation data is sent to regulating device (158) by the sensor and correction measure are taken by regulating device to correct such deviations by adjusting the stamping foil and stamping punch.

The regulating device (158) is connected on the input side to different sensors such as optical sensors, rotary encoders, tension sensor, pressure sensor etc. and on output side to different drives which are driven by servo motors. The sensors provide input from various locations as described above in real time. All the drives are fitted with servo motors, which are controlled by output from regulating device based on input from the sensors and set relationship between various parameters.

The regulating device (158) takes inputs from the sensing devices (160, 162, 164, 166, 168 and 135) and based on different data and set relationship and adjusts the stamping foil (116) with the help of feed rollers (144A) and adjusting rollers (144B) and the corresponding positions of stamping punch (137) by means of the servo motor to ensure stamping in accurate registration. The stamping roller (136) and stamping foil (116) are adjusted in a defined manner in relation to the flexible substrate (110).

The stamping roller (136) of a length corresponding to the width of the substrate (110) is provided with stamping punches (137) which are equidistantly spaced from each other in the outer surface of the stamping roller (136). The spacing between adjacent stamping punch (137) precisely corresponds to the pitch of the print portions (112) of the flexible substrate (110) which are configured in a row one behind the other (see FIG. 1).

As already discussed, the stamping roller (136) is driven by servo motor which enables it to rotate clock-wise/anti clock-wise to adjust the position of stamping punch (137). It is contemplated that, the pitch of the stamping punch may not be exactly same as the pitch of the desired location (112) of the substrate (110). In that case the stamping roller is adjusted in such a manner that the stamping punch falls precisely at exact position of the desired location (112) of the substrate (110) and the transfer areas (118) of the stamping foil (116).

The sensors (168, 166), which are provided on the rewind side of stamping station, detect the accuracy of the stamping and send the accuracy data to regulating device. Based on the accuracy information corrective measures are taken by regulating device instantly. Therefore, the sensors on the rewind side in combination with various sensors on unwind side and different drives form a close loop mechanism. The sensor (168) on rewind side of the stamping station form close loop with the sensor (162) on the unwind side of the stamping station and the sensor (166) on rewind side of the stamping station form close loop with the sensors (162 & 164) on the unwind side of the stamping station. Due to this close loop mechanism any error in stamping is corrected continuously without wastage of foil or substrate.

In an alternate embodiment a supply device (not shown) may be used with the apparatus to provide a continuous length of substrate. A device for applying a patch of primer or an adhesive on the substrate in registered relationship or all over may also be provided to enhance bonding strength.

A process for precise positioning of a stamping foil (116), a stamping roller (136) and a substrate (110), the method comprising the steps of:

a. registering the stamping roller (136) with respect to the moving substrate (110), based on positional data sent by the sensor (160) and the sensor (164) which send corresponding signals to a regulating device (158) for adjusting the stamping roller (136)

b. registering the stamping foil (116) with respect to the stamping roller (136), the regulating device (158) performs adjustment measures on the signals received from the sensor (162) and the sensor (164 or 160);

c. validating and/or correcting positional errors in the registration of the stamping foil (116) upon receiving signals from a sensor (168) associated with used stamping foil; and

d. validating and/or correcting positional errors in the registration of the stamping foil (116) and stamping punch (137) with respect to the substrate (110), the regulating device (158) performs corrective measures on receiving information from a camera (166) associated with stamped substrate (110).

After foil prints, latent images or Fresnel lenses have been stamped out on the flexible substrate (110), a re-wind roll (154) is provided for collection of stamped flexible substrate (110). At the same time the used stamping foil (116) is also wound on to a winding-on roll (156).

Although the invention is explained with specific reference to servo motors to run the different drives, it may be contemplated that stepper motors and like devices may be used for the purpose.

The present invention removes the drawbacks of inaccurate registration due to varying speed of different rollers in the system and inherent inaccuracies in printing and manufacturing process of the substrate, stamping foil and stamping roller. The use of high resolution and high speed sensors provides continuous precise data to the regulating device which results in the continuous correction in the corresponding position of stamping punch and stamping foil to match the location on substrate. This provides accurate registered transfer of prints, latent images or Fresnel lenses on the substrate with efficient utilization of stamping foil.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof.

I claim:

1. An apparatus for transferring images, barcodes, optical patterns, latent images, Fresnel lenses, holograms, sterling lenses etc. by stamping from a stamping foil with accurate registration on a flexible substrate in roll to roll form, the apparatus comprising:
a first unwind roll (140) to provide flexible substrate (110) which is pulled off the unwind roll (140) by at least a pair of feed rollers (132A) and adjusting rollers (132B) working in tandem;
a second unwind roll (142) to provide stamping foil (116) which is drawn off the unwind roll (142) by at least a pair of feed rollers (144A) and adjusting rollers (144B) working in tandem;
a stamping station (134) having a stamping roller (136) with stamping punches (137) configured to the outer surface of the stamping roller (136) and a pressing roller (120) provided against the stamping roller to provide necessary pressing of the stamping foil over the substrate for stamping;
a multiplicity of sensors (135, 160, 162, 164, 166, 168) associated with each of the substrate, the stamping foil, the stamping roller, the stamped substrate and used stamping foil to sense the respective positions of the substrate, the stamping foil and the stamping roller;
a regulating device (158) configured to take input from different sensors, calculate, compare and to control the rotation of different roller drives to adjust the position of the stamping foil and the stamping punch by clock-wise/anti clock-wise rotation of the drives;
a first re-wind roll (154) provided for collection of stamped flexible substrate (110); and
a second re-winding roll (156) for collection of used stamping foil (116).

2. The apparatus as claimed in claim 1, wherein the rollers (132A, 132b, 144A, 144B, 136) are driven by servo motors controlled by the regulating device (158).

3. The apparatus as claimed in claim 1, wherein the diameter and rotational speed of the feed rollers (132A) and the adjusting rollers (132B) are predetermined and fed to the regulating device (158) to determine the speed of the substrate web.

4. The apparatus as claimed in claim 1, wherein the stamping foil feed rollers (144A) and the adjusting rollers (144B) are rotatable clockwise/anticlockwise in tandem with each other to adjust the position of stamping foil (116) with respect to the corresponding sensed registration mark (111) on the substrate.

5. The apparatus as claimed in claim 1, wherein the stamping roller (136) rotatable clockwise/anticlockwise by servo motor controlled by the regulating device (158).

6. The apparatus as claimed in claim 1, wherein the sensor (160) associated with the substrate (110) senses the pitch on the substrate (110) and sends the information to the regulating device (158).

7. The apparatus as claimed in claim 1, wherein a tension sensor (135) for measurement of tension in the substrate is provided between the feed rollers (132A) and the adjustment rollers (132B), which measures tension in the substrate and sends signals to the regulating device (158).

8. The apparatus as claimed in claim 1, wherein the sensor (162) associated with the stamping foil (116) senses the registration mark on the stamping foil (116) corresponding to the registration mark (111) on the substrate (110) and sends the information to the regulating device (158).

9. The apparatus as claimed in claim 1, wherein the sensor (164) associated with stamping roller (136) senses the position of the stamping punch (137) corresponding to the registration mark (111) on the substrate (110) and sends the information to the regulating device (158).

10. The apparatus as claimed in claim 1, wherein the sensor (166), is provided after stamping station to sense the accuracy of transferred images, barcodes, optical patterns, latent images, Fresnel lenses, holograms, sterling lenses etc. stamped on the substrate and to send the variation data to the regulating device (158).

11. The apparatus as claimed in claim 10, wherein the sensor (166) is a high resolution, high speed online inspection camera.

12. The apparatus as claimed in claim 1, wherein the sensor (168) is provided after the stamping station to sense the eye mark or registration mark and transferred impression/portion on used stamping foil (116) and sends the information to the regulating device (158).

13. The apparatus as claimed in claim 1, wherein the regulating device (158) is a PLC (programmable logic controller) or a computer based system capable of receiving multiple inputs from sensors, calculating, comparing & providing outputs for corresponding controlling devices.

14. The apparatus as claimed in claim 1, wherein the sensors (168) on rewind side of the stamping station form close loop with the sensor (162) on the unwind side of the stamping station.

15. The apparatus as claimed in claim 1, wherein the sensors (166) on rewind side of the stamping station form close loop with the sensor (162 & 164) on the unwind side of the stamping station.

16. A process for transferring images, barcodes, optical patterns, latent images, Fresnel lenses, holograms, sterling lenses etc. from a stamping foil with accurate registration on a flexible substrate in roll to roll form, the process comprising the steps of:
providing a flexible substrate (110) from a substrate unwind roll (140), the substrate (110) pulled by at least a pair of feed rollers (132A) and adjusting rollers (132B) working in tandem;
reading the positional data of the registration mark (111) on the substrate (110) by the sensor (160) and sending the positional data to regulating device (158);
adjusting the stamping punch (137) on the stamping roller (136) according to positional data of the registration mark (111) on the substrate (110);
providing a stamping foil (116) from an unwind roll (142), the stamping foil drawn off by at least a pair of feed rollers (144A) and adjusting rollers (144B) working in tandem;
adjusting the corresponding positions of the stamping foil (116) with respect to corresponding position of the substrate (110) and the stamping punch (136);
transferring images, barcodes, optical patterns, latent images, Fresnel lenses, holograms, sterling lenses from stamping foil (116) to the substrate (110) at the stamping station (134) by stamping; and
collecting the substrate on a rewind roll (154) and used stamping foil (116) on rewind roll (156).

17. The process as claimed in claim 16, wherein tension in the substrate web (110) is measured by a tension sensor (135) provided between the feed rollers (132A) and the adjustment rollers (132B).

18. The process as claimed in claim 16, wherein the feed rollers (132A) and the adjusting rollers (132B) work in tandem to maintain constant tension in the substrate (110) web using data received from the tension sensor (135).

19. The process as claimed in claim 16, wherein the stamping foil is pulled back and forth by the feed rollers (144A) and the adjusting rollers (144B) to adjust position of the stamping foil with respect to corresponding position on the substrate (110).

20. The process as claimed in claim 16, wherein the sensor (160) associated with the substrate (110) senses the registration mark (111) on the substrate (110) and sends the information to the regulating device (158).

21. The process as claimed in claim 16, wherein corresponding pitch on the stamping foil (116) is detected by the sensor (162) and the information is sent to the regulating device (158) to adjust the stamping foil (116) with respect to substrate (110).

22. The process as claimed in claim 16, wherein the position of corresponding stamping punch (137) is sensed by the sensor (164) connected to the regulating device (158) and adjusted with respect to stamping substrate (110).

23. The process as claimed in claim 16, wherein the sensor (166) on rewind side of the stamping station detects the variation in the position of stamping on substrate (110).

24. The process as claimed in claim 16, wherein a sensor (168) senses the eye mark or registration mark and transferred impression/portion on used stamping foil (116) and sends the variation data to the regulating device for further correction through (144A) & (144B).

25. The process as claimed in claim 16, wherein the sensors (168) on rewind side of the stamping station form close loop with the sensor (162) on the unwind side of the stamping station.

26. The process as claimed in claim 16, wherein the sensors (166) on rewind side of the stamping station form close loop with the sensor (162 & 164) on the unwind side of the stamping station.

27. A process for precise positioning of a stamping foil (116), a stamping roller (136) and a substrate (110), the method comprising the steps of:
a. registering the stamping roller (136) with respect to the moving substrate (110), based on positional data sent by the sensor (160) and the sensor (164) which send corresponding signals to a regulating device (158) for adjusting the stamping roller (136)
b. registering the stamping foil (116) with respect to the stamping roller (136), the regulating device (158) performs adjustment measures on the signals received from the sensor (162) and the sensor (164 or 160);
c. validating and/or correcting positional errors in the registration of the stamping foil (116) upon receiving signals from a sensor (168) associated with used stamping foil; and
d. validating and/or correcting positional errors in the registration of the stamping foil (116) and stamping punch (137) with respect to the substrate (110), the regulating device (158) performs corrective measures on receiving information from a camera (166) associated with stamped substrate (110).
